(19) United States
(12) Patent Application Publication
(10) Pub. No.: US 2025/0025824 A1
(43) Pub. Date: Jan. 23, 2025

(54) AMMONIA ADSORPTION TOWER OPERATING CONTROL DEVICE AND CONTROL METHOD USING THE SAME

(71) Applicant: SK INNOVATION CO., LTD., Seoul (KR)

(72) Inventors: Jae Jeong KIM, Daejeon (KR); Chan Saem PARK, Daejeon (KR); Sun Hyuk BAE, Daejeon (KR)

(21) Appl. No.: 18/773,583

(22) Filed: Jul. 16, 2024

(30) Foreign Application Priority Data
Jul. 21, 2023 (KR) 10-2023-0095511

(51) Int. Cl. B01D 53/04

(52) U.S. Cl. CPC B01D 53/0454; B01D 2257/406

(57) ABSTRACT

An ammonia adsorption tower operating control device according to the present disclosure includes: a sensor unit configured to measure an internal state of an adsorption tower; a memory configured to store one or more instructions; a processor configured to execute one or more instructions stored in the memory; and a operating unit configured to operate the adsorption tower according to an adsorption cycle and a desorption cycle set based on the internal state of the adsorption tower. The processor is configured to output corresponding adsorption cycle and desorption cycle according to sensing data of the sensor unit using a trained artificial intelligence model. When the sensing data is within a preset optimal range, transmit a command to operate the adsorption tower according to the output adsorption cycle and desorption cycle to the operating unit.

### CROSS-REFERENCE TO RELATED APPLICATION AND CLAIM OF PRIORITY

This application claims priority to Korean Patent Application No. 10-2023-0095511 filed on Jul. 21, 2023, the entire disclosure of which is incorporated by reference herein.

### BACKGROUND OF THE INVENTION

### 1. Field of the Invention

The present disclosure relates to an ammonia adsorption tower operating control device and control methods using the same.

### 2. Description of the Related Art

Ammonia is one of the substances that cause mal odors, and may be generated not only in livestock farms but also in composting facilities, factories, sewage treatment plants, and the like, which use chemical fertilizers or chemical fibers.

Conventionally, ammonia is adsorbed and removed from air by an adsorption tower. When a predetermined level of ammonia is absorbed, a reduction in the removal efficiency of the adsorption tower may result. At that point, desorbing of the ammonia is required to allow the adsorption tower to continue operating.

In order to repeatedly perform the above-described processes (adsorption/desorption), it is very important to control adsorption and desorption cycles so that the adsorption and desorption processes are performed timely. Conventionally, volatile organic compounds (VOCs) adsorbed on an adsorbent are desorbed by a vapor recovery method using steam. The desorbed vapor and VOCs are then recovered through a heat exchanger in order to be reused. In this case, a temperature sensor provided in the adsorption tower is used to determine the desorption time (i.e., when to desorb the VOCs from the adsorbent).

However, even if the desorption time is detected or an occurrence of an abnormality indicating that the desorption time has past, and an operator does not perform a process to resolve the abnormal state in time, the adsorption efficiency is decreased. In addition, even if the operator responds timely, methods for responding to the abnormal state are vary depending on skill levels of the operators, such that the adsorption efficiency cannot be maintained consistently.

Further, even if an artificial intelligence model is used, erroneous training of the artificial intelligence model may also have an adverse effect on prediction of the adsorption and desorption cycles in the normal state. The erroneous training is usually due to incorrect values of the abnormal state used to train the artificial intelligence model.

### SUMMARY OF THE INVENTION

According to one aspect of the present disclosure, it is an object to provide an artificial intelligence-based ammonia adsorption tower driving control device and a control method using the same, in which an abnormal situation processing process according to the exception adsorption cycle and the exception desorption cycle may be executed when an abnormal state occurs regardless of the predicted adsorption and desorption cycles, and thereby contributing to environmental friendliness and producing clean energy.

To achieve the above mentioned object, according to an aspect of the present invention, there is provided an ammonia adsorption tower operate control device including: a sensor unit configured to measure an internal state of an adsorption tower; a memory configured to store one or more instructions; a processor configured to execute one or more instructions stored in the memory; and a operating unit configured to operate the adsorption tower according to an adsorption cycle and a desorption cycle set based on the internal state of the adsorption tower, wherein the processor is configured to: output corresponding adsorption cycle and desorption cycle according to sensing data of the sensor unit using a trained artificial intelligence model; in response to the sensing data being within a preset optimal range, transmit a command to operate the adsorption tower according to the output adsorption cycle and desorption cycle to the operating unit; and in response to the sensing data exceeding the optimal range, transmit a command to execute an abnormal situation processing process according to preset exception adsorption cycle and exception desorption cycle to the operating unit.

According to one embodiment, the exception adsorption cycle and the exception desorption cycle are the shortest adsorption cycle and the longest desorption cycle within a settable cycle range of the operating unit.

According to one embodiment, when the command to execute the abnormal situation processing process includes parameters according to at least one of: a minimum adsorption flow rate and a maximum desorption flow rate within a operable range of the operating unit; a minimum adsorption temperature and a maximum desorption temperature within a operable range of the operating unit; and a minimum adsorption pressure and a maximum desorption pressure within a operable range of the operating unit.

According to one embodiment, the processor is further configured to repeatedly perform self-diagnose at a preset cycle to determine whether the sensing data measured by the sensor unit deviate from the optimal range or whether patterns of previous sensing data and subsequent sensing data are different.

According to one embodiment, after operating the adsorption tower according to the abnormal situation processing process until the sensing data measured by the sensor unit is within the optimal range, the processor transmits a command to operate the adsorption tower using the adsorption cycle and desorption cycle output from the trained artificial intelligence model to the operating unit.

According to one embodiment, the processor is further configured to the following: in response to a previous adsorption cycle and a previous desorption cycle which are performed before operating the adsorption tower according to the abnormal situation processing process being different from a next adsorption cycle and a next desorption cycle which will be used to operate the adsorption tower after the abnormal situation processing process ends, calculate costs and time reduction data when operating the adsorption tower by the operating unit using the next adsorption cycle and the next desorption cycle.

According to one embodiment, the processor transmits a command to maintain the previous adsorption cycle and the previous desorption cycle to the operating unit, in response to the calculated costs and time reduction not exceeding a preset threshold value.

According to one embodiment, sensing data in the abnormal state are removed and only sensing data in the normal state are transmitted to the artificial intelligence model at each point in the process so that the abnormal state is detected by the artificial intelligence model.

According to one embodiment, the device further includes a user interface configured to provide an alarm to a user in response to detection of an abnormal, and to receive information on the abnormal situation processing process.

According to one embodiment, the sensor unit includes a pressure sensor, a temperature sensor, a humidity sensor, a gas sensor, an adsorbent sensor, or combinations thereof, and the processor transmits a command to stop operating of the adsorption tower to the operating unit, in response to an occurrence of error in the sensor unit, the error being detected through self-diagnosis or a communication error between the sensor unit and the processor.

According to another aspect of the present invention, there is provided an ammonia adsorption tower operation control method executed by a computing device which includes a memory configured to store one or more instructions and a processor configured to execute the one or more instructions stored in the memory, the method including: collecting sensing data obtained by measuring an internal state of an adsorption tower; and operating the adsorption tower according to an adsorption cycle and a desorption cycle set based on the sensing data, wherein the step of operating the adsorption tower further includes: outputting corresponding adsorption cycles and desorption cycles according to the sensing data using a trained artificial intelligence model; transmitting a command to operate the adsorption tower according to the output adsorption cycle and desorption cycle to a operating unit of the adsorption tower, in response to the sensing data being within a preset optimal range; and transmitting a command to execute an abnormal situation processing process according to preset exception adsorption cycle and exception desorption cycle to the operating unit of the adsorption tower, in response to the sensing data exceeds the optimal range.

According to another aspect of the present invention, there is provided a computer program product for controlling an ammonia adsorption tower operation, the computer program product comprising a computer readable storage medium having a program instructions stored therein, the program instructions executable by a processor to collect sensing data obtained by measuring an internal state of an adsorption tower; and operate the adsorption tower according to an adsorption cycle and a desorption cycle set based on the sensing data. To operate the adsorption tower the program instructions are executable by the processor to output corresponding adsorption cycle and desorption cycle according to the sensing data using a trained artificial intelligence model, transmit a command to operate the adsorption tower according to the output adsorption cycle and desorption cycle to a operating unit of the adsorption tower, in response to the sensing data being within a preset optimal range, and transmit a command to execute an abnormal situation processing process according to preset exception adsorption cycle and exception desorption cycle to the operating unit of the adsorption tower, in response to the sensing data exceeding the optimal range.

The present disclosure may maximize cost-effectiveness and adsorption efficiency by quickly restoring the internal state of the adsorption tower to a normal state by executing the abnormal situation processing process when an abnormal state occurs regardless of the predicted adsorption and desorption cycles.

In addition, the present disclosure may maximize adsorption efficiency through reductions in costs and time according to changes in operating conditions, by performing verification of the operating conditions before operating the adsorption tower according to the predicted adsorption and desorption cycles output by the artificial intelligence model so as to change the operating conditions depending on the costs occurring when changing the adsorption and desorption cycles and the operating performance efficiency to be improved.

### BRIEF DESCRIPTION OF THE DRAWINGS

The above and other objects, features and other advantages of the present invention will be more clearly understood from the following detailed description taken in conjunction with the accompanying drawings, in which:

FIG. 1a is a conceptual diagram schematically illustrating an adsorption tower according to an embodiment of the present disclosure, and FIG. 1b shows conceptual graphs illustrating changes in adsorption efficiency depending on changes in the temperature over time;

FIG. 2 is a block diagram schematically illustrating the configuration of an ammonia adsorption tower operating control device according to an embodiment of the present disclosure;

FIG. 3 is a flow chart illustrating a method for controlling an ammonia adsorption tower operation according to an embodiment of the present disclosure;

FIG. 4 is a flow chart illustrating specific procedures for controlling the ammonia adsorption tower operation according to an embodiment of the present disclosure;

FIG. 5 is a flow chart illustrating procedures for controlling the ammonia adsorption tower operation when an abnormal state occurs in the adsorption tower according to an embodiment of the present disclosure; and

FIG. 6 is a block diagram illustrating a computing device according to an embodiment of the present disclosure.

### DETAILED DESCRIPTION OF THE INVENTION

Hereinafter, the present disclosure will be described in detail through embodiments with reference to the accompanying drawings. However, the embodiments are illustrative, and the present disclosure is not limited to the specific embodiments described by way of example.

The same reference numerals are denoted to the same components throughout the present disclosure. The present disclosure does not describe all elements of the embodiments, and general contents in the technical field to which the present disclosure pertains or overlapping contents between the embodiments will not be described. The terms “unit”, “module”, “member”, or “block” used herein may be implemented as software or hardware, and depending on the embodiments; a plurality of “units”, “modules”, “members”, “blocks” may be implemented as one component; or one “part”, “module”, “member”, or “block” may include a plurality of components.

Throughout the specification, when the explanatory phrase a part is “connected” to another part is used, this includes not only the case where the part is “directly connected” to the other part, but also the case where the part is “indirectly connected” to the other part, and the indirect connection includes connection, e.g., through a wireless communication network.

In addition, when the explanatory phrase a part “comprises or includes” a component is used, this means that the part may further include the component without excluding other components, unless there is a description opposite thereto.

Throughout the specification, when the explanatory phrase a member is located “on” another member is used, this includes not only the case where the member is in contact with the other member, but also the case where another member exists between the two members.

The singular forms “a,” “an” and “the” are intended to include the plural forms as well, unless the context clearly indicates otherwise.

The identification numerals for each step is used for the convenience of description. The identification numerals do not describe the order of each step, and each step may be performed differently from the specified order unless a specific order is clearly described in the context.

In this specification, the phrase “device according to the present disclosure” includes all various devices that can perform computational processing and provide results thereof to a user. For example, the “device according to the present disclosure” may include any of a computer, a server device, and a portable terminal, or may be any form thereof.

Here, the computer may include, for example and not limited to, a laptop or desktop computer, laptop PC, tablet PC, slate PC, etc. equipped with a web browser.

The server device is a server that processes information by performing communication with an external device, and may include an application server, computing server, database server, file server, game server, mail server, proxy server, web server, and combinations thereof.

The portable terminal is, for example, a wireless communication device with which portability and mobility are assured, and may include, but not limited to: any type of handheld wireless communication devices such as a personal communication system (PCS), global system for mobile communications (GSM), personal digital cellular (PDC), personal mobile phone system, personal digital assistant (PDA), international mobile telecommunication (IMT)-2000, code division multiple access (CIMA)-2000, wideband code division multiple access (W-CIMA), wireless broadband internet (WiBro) terminal, and smart phone, etc.; and wearable devices such as a watch, ring, bracelet, anklet, necklace, glasses, contact lenses, and head-mounted-device (HMD), etc.

Functions related to artificial intelligence according to one embodiment of the present disclosure are operated through a processor and a memory. The processor may include one or a plurality of processors. In this case, the one or plurality of processors may be general-purpose processors, such as but not limited to, a central processing unit (CPU), an application processor (AP), or digital signal processor (DSP), etc., dedicated graphics processors such as a GPU or vision processing unit (VPU), etc., or dedicated artificial intelligence processors such as a Neural Processing Unit (NPU). The one or plurality of processors control to process input data according to predefined operation rules or artificial intelligence models stored in the memory. Alternatively, when the one or plurality of processors are dedicated artificial intelligence processors, the artificial intelligence dedicated processors may be designed with a hardware structure specialized for processing a specific artificial intelligence model.

The predefined operation rule or artificial intelligence model are characterized by being generated or trained through learning. As used herein, the expression “being generated or trained through learning” means that the basic artificial intelligence model is trained using learning data by a learning algorithm, thereby generating a predefined operation rule or artificial intelligence model set to perform the desired characteristics (or purposes). This learning may be accomplished in the device itself on which the artificial intelligence is performed according to the present disclosure, or may be accomplished through a separate server and/or system. Examples of learning algorithms include, but are not limited to, supervised learning, unsupervised learning, semi-supervised learning, reinforcement learning, or combinations thereof.

The artificial intelligence model may consist of a plurality of neural network layers. Each of the plurality of neural network layers may include a plurality of weight values, performs neural network calculation through calculations between the calculation results of the previous layer and the plurality of weight values. The plurality of weight values assigned to the plurality of neural network layers may be optimized by the learning results of the artificial intelligence model. For example, the plurality of weight values may be updated so that loss or cost values obtained from the artificial intelligence model are reduced or minimized during the learning process. The artificial neural network may include a deep neural network (DNN), such as but not limited to, a convolutional neural network (CNN), deep neural network (DNN), recurrent neural network (RNN), restricted Boltzmann machine (RBM), deep belief network (DBN), bidirectional recurrent deep neural network (BRDNN), or Deep Q-Networks, etc.

According to an exemplary embodiment of the present disclosure, the processor may implement artificial intelligence. As used herein, the artificial intelligence refers to a machine learning method based on an artificial neural network which causes the machine to perform learning by imitating human biological neurons. Methodology of artificial intelligence may be divided, according to the learning method, into: supervised learning in which the answer (output data) to the question (input data) is defined by providing input data and output data together as training data; unsupervised learning in which the answer (output data) to the question (input data) is not determined by providing only input data without output data; and reinforcement learning in which a reward is given from an external environment whenever any action is taken in the current state, and training is performed in a direction of maximizing this reward. In addition, the methodology of artificial intelligence may be divided according to an architecture which is the structure of learning model. The architecture of widely used deep learning technology may be divided into a convolutional neural network (CNN), recurrent neural network (RNN), transformer, generative adversarial networks (GAN), etc.

The device and system of the present disclosure may include artificial intelligence models. The artificial intelligence model may be implemented as a single artificial intelligence model or a plurality of artificial intelligence models. The artificial intelligence model may include neural networks (or artificial neural networks) which may include statistical learning algorithms which mimic biological neurons in machine learning and cognitive science. The neural network may refer to an overall model in which artificial neurons (nodes) forming a network through the combination of synapses change the coupling strength of the synapses through learning to have problem solving skills. Neurons in the neural network may include the combination of weight values or biases. The neural network may include one or more layers consisting of one or more neurons or nodes. As an example, the device may include an input layer, a hidden layer, and an output layer. The neural network including the device may infer the result (output) to be predicted from arbitrary input (input) by changing the weight values of neurons through learning.

The processor may generate a neural network, cause the neural network to perform training through learning, perform calculation based on the received input data, generate information signals based on the execution results, cause the neural network to perform retraining, or combinations thereof. Models of the neural network may include, but are not limited to, various types of models, such as, GoogleNet, AlexNet, VGG Network, etc., for example and not limited to, convolution neural network (CNN), region with convolution neural network (R-CNN), region proposal network (RPN), recurrent neural network (RNN), stacking-based deep neural network (S-DNN) state-space dynamic neural network (S-SDNN), deconvolution network, deep belief network (DBN), restricted Boltzmann machine (RBM), fully convolutional network (FCN), long short-term memory (LSTM) network, classification network, and the like. The processor may include one or more processors to perform calculations according to models of the neural network. For example, the neural network may include a deep neural network.

The neural network may include, for example and not limited to, the convolutional neural network (CNN), recurrent neural network (RNN), perceptron, multilayer perceptron, feed forward (FF), radial basis network (RBF), deep feed forward (DFF), long short term memory (LSTM), gated recurrent unit (GRU), auto encoder (AE), variational auto encoder (VAE), denoising auto encoder (DAE), sparse auto encoder (SAE), Markov chain (MC), Hopfield network (HN), Boltzmann machine (BM), restricted Boltzmann machine (RBM), deep belief network (DBN), deep convolutional network (DCN), deconvolutional network (DN), deep convolutional inverse graphics network (DCIGN), generative adversarial network (GAN), liquid state machine (LSM), extreme learning machine (EIM), echo state network (ESN), deep residual network (DRN), differential neural computer (DNC), neural turning machine (NTM), capsule network (CN), Kohonen network (KN) and/or attention network (AN. Those skilled in the art will understand that the neural network of the present disclosure may include any neural network.

According to one embodiment of the present disclosure, the processor may include various artificial intelligence structures and algorithms, such as and not limited to, GoogleNet, AlexNet, VGG Network, etc., for example, convolution neural network (CNN), region with convolution neural network (R-CNN), region proposal network (RPN), recurrent neural network (RNN), stacking-based deep neural network (S-DNN) state-space dynamic neural network (S-SDNN), deconvolution network, deep belief network (DBN), restricted Boltzmann machine (RBM), fully convolutional network (FCN), long short-term memory (LSTM) network, classification network, generative modeling, eXplainable AI, Continual AI, representation learning, AI for material design, BERT for natural language processing, SP-BERT, MRC/QA, Text Analysis, Dialog System, GPT-3, GPT-4, Visual Analytics for vision processing, Visual Understanding, Video Synthesis, Anomaly Detection for ResNet data intelligence, Prediction, Time-Series Forecasting, Optimization, Recommendation, Data Creation, and/or the like.

Hereinafter, embodiments of the present disclosure will be described in detail with reference to the accompanying drawings.

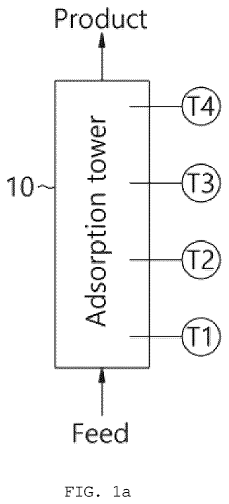

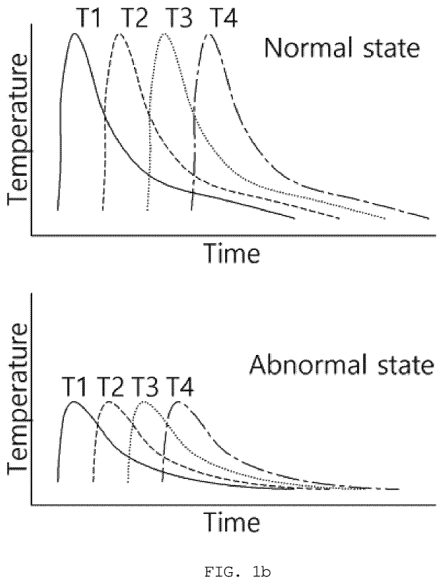

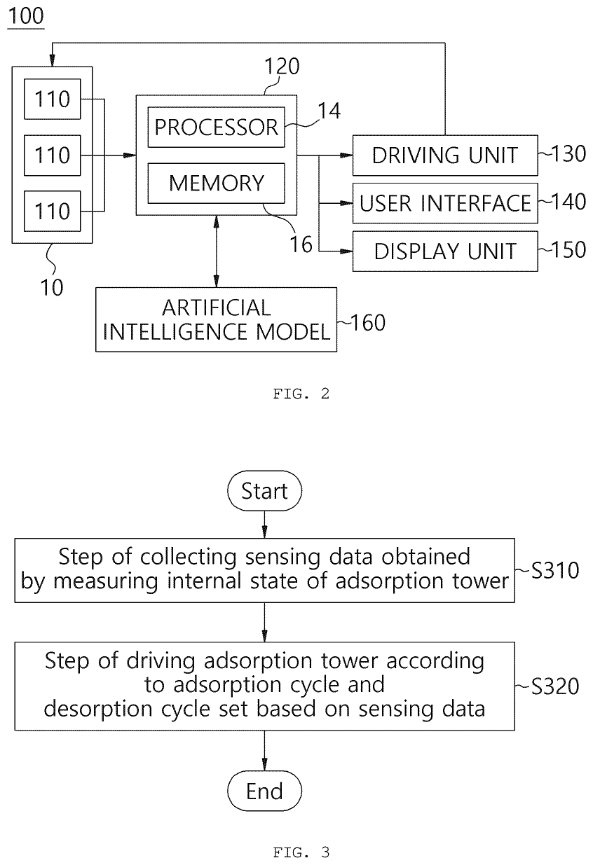

FIG. 1a is a conceptual diagram schematically illustrating an adsorption tower 10 according to an embodiment of the present disclosure, and FIG. 1b shows conceptual graphs illustrating changes in adsorption efficiency depending on changes in the temperature over time. Hereinafter, the above-described artificial intelligence-based ammonia adsorption tower operating control device and control method using the same will be described in detail with reference to FIGS. 2 to 5.

As shown in FIG. 1a, the adsorption tower 10 may receive a gas feed containing ammonia, volatile organic compounds (VOCs), etc., and discharge the gas in a product stream from which the ammonia and volatile organic compounds (VOCs) have been removed by applying a vapor recovery method such as recompression, condensation, and activated carbon adsorption while passing from regions T1 to T4.

The adsorption tower 10 may have regions T1, T2, T3 and T4 between a location close to an inlet port into which the feed is input to a location of an outlet port from which the product is discharged, and may include sensor units (110, see FIG. 2) installed in each of the regions. The sensor unit 110 may include at least one of a pressure sensor for measuring an internal pressure of the adsorption tower 10, a temperature sensor for measuring an internal temperature of the adsorption tower 10, a humidity sensor for measuring an internal humidity of the adsorption tower 10, a gas sensor for measuring a gas component inside the adsorption tower 10 to determine a purity of the extracted hydrogen, and an adsorbent sensor.

It is possible to determine whether the pressure or temperature is controlled within a predetermined range to maintain adsorption efficiency using the sensor unit 110, and calculate result values regarding hydrogen extraction efficiency using the detected humidity or hydrogen purity.

In addition, the adsorbent sensor of the sensor unit 110 may measure the state of the adsorbent inside the adsorption tower, evaluate the life-span and performance of the adsorbent, and obtain information capable of predicting the replacement time of the adsorbent.

As shown in FIG. 1b, the temperature is increased as adsorption is activated, but as the adsorption efficiency is decreased and the replacement time of the adsorbent approaches, the range of increase in the temperature is decreased (compare the top graph to the bottom graph in FIG. 1b). Thus, it is possible to grasp a change in the state of the adsorbent depending on the amount of change in temperature.

In this case, it can be apparent that the contact time with the feed is delayed toward T4 from T1, such that the adsorbent replacement time (of T2, T3, or T4) occurs later than T1, and that all the adsorbent replacement times of T1 to T4 do not occur at the same time.

In addition, when an abnormal state occurs, the range of change in the internal temperature of the adsorption tower 10 is decreased even though the adsorbent replacement time has not yet arrived, which may lead to a misconception that the replacement time of the adsorbent has arrived.

Therefore, an artificial intelligence-based ammonia adsorption tower operating control device 100 according to an embodiment of the present disclosure may include, as shown in FIG. 2, the sensor unit 110 configured to measure an internal state of the adsorption tower 10, a memory 16 configured to store one or more instructions, a processor 14 configured to execute one or more instructions stored in the memory 16, and a operating unit 130 configured to operate the adsorption tower 10 according to the adsorption cycle and desorption cycle set based on the internal state of the adsorption tower 10.

The sensor units 110 may be disposed at regions T1 to T4 inside of the adsorption tower 10, respectively.

As an example, the inside of the adsorption tower 10 is separated and partitioned into a plurality of beds, and the sensor units 110 may be installed respectively in the separated and partitioned beds.

As another example, a plurality of adsorption towers 10 are connected, and the sensor units 110 may be installed respectively in each of the adsorption towers 10.

In other words, the sensor units 110 may be installed for each divided space in at least one adsorption tower 10 separated into individual spaces by dividing one adsorption tower 10 into a plurality of beds or connecting a plurality of adsorption towers 10, etc.

The processor 14 and the memory 16 may be disposed together or separately in one or more computing devices 120 (as illustrated in FIG. 2). Operating of the adsorption tower 10 may be controlled using the computing device 120 so as to be operaten while the efficiency of the adsorption tower 10 is maintained at a predetermined level or higher.

The artificial intelligence model 160 may be disposed in the computing device 120 together or connected thereto through a separate server or cloud.

In addition, the artificial intelligence-based ammonia adsorption tower operating control device 100 according to an embodiment of the present disclosure may further include a user interface 140 to receive user input for operating the adsorption tower 10 (as illustrated in FIG. 2).

The user interface 140 may provide an alarm to the user when an abnormal state occurs, and receive information on the abnormal situation processing process.

In addition, the artificial intelligence-based ammonia adsorption tower operating control device 100 according to an embodiment of the present disclosure may further include a display unit 150 (as illustrated in FIG. 2) configured to provide an alarm for operating the adsorption tower 10 or monitor an operation status of the adsorption tower 10 in real time, and display the monitoring results.

In one embodiment, the processor 14 may be configured to: output the corresponding adsorption cycle and desorption cycle according to the sensing data of the sensor unit 110 using the trained artificial intelligence model 160. When the sensing data is within a preset optimal range, the processor 14 transmits to the operating unit 130 a command to operate the adsorption tower according to the output adsorption cycle and desorption cycle. When the sensing data exceeds the optimal range, the processor 14 transmits to the operating unit 130 a command to execute the abnormal situation processing process according to the preset exception adsorption cycle and exception desorption cycle.

The artificial intelligence-based ammonia adsorption tower operating control device 100 may identify the abnormal state based on data collected from the sensor units 110. When an abnormal state occurs, the processor 14 detects the abnormal state in real time using the artificial intelligence model 160 which is trained to detect the normal state for the pressure, temperature, humidity, concentration of the gas, and other conditions, in the adsorption tower 10 at each point in the adsorption process.

The processor 14 of the artificial intelligence-based ammonia adsorption tower operating control device 100 may repeatedly self-diagnose at a preset cycle to determine whether the sensing data measured by the sensor unit 110 deviates from the optimal range or whether patterns of previous sensing data and subsequent sensing data are different. When an abnormal state occurs, the processor 14 detects the abnormal state in real time using the artificial intelligence model 160.

In addition, when performing self-diagnosis, the processor 14 may not only detect an abnormal state inside the adsorption tower 10, but also detect a sensor error in at least one sensor of the sensor unit 110, or detect a communication error between the sensor unit 110 and the processor 14. When a sensor error or communication error is detected, the processor 14 transmits to the operating unit 130 a command to stop the operating of the adsorption tower 10.

As an example, when a normal state is identified, the processor 14 may execute the adsorption process with optimal efficiency using the adsorption cycle and desorption cycle output by the artificial intelligence model 160. As used herein, the optimal efficiency means a state where adsorption efficiency of a predetermined level or more can be maintained while reducing costs by delaying the replacement time of the adsorbent as long as possible.

As an example, when an abnormal state is identified, the processor 14 may not execute the adsorption process at the adsorption cycle and desorption cycle output by the artificial intelligence model 160, but operate a preset abnormal situation processing process to periodically transmit a command to operate the adsorption tower 10 at adsorption and desorption cycles that allow the fastest recovery to the normal state.

Here, the adsorption and desorption cycles that allow the fastest recovery to the normal state are preset exception adsorption cycle and exception desorption cycle, and the exception adsorption cycle and the exception desorption cycle may be the shortest adsorption cycle and the longest desorption cycle within a settable cycle range of the operating unit 130.

Alternatively, when the processor 14 transmits a command to execute the abnormal situation processing process to the operating unit 130, the command may include parameters according to at least one of a minimum adsorption flow rate and a maximum desorption flow rate, or a minimum adsorption temperature and a maximum desorption temperature, or a minimum adsorption pressure and a maximum desorption pressure within a operable range of the operating unit 130, respectively.

Specifically, the processor 14 may transmit an exception parameter corresponding to an abnormal situation other than the exception adsorption cycle and the exception desorption cycle to the operating unit 130. The processor 14 may transmit the minimum adsorption flow rate and maximum desorption flow rate within the operable range of the operating unit 130, thereby measuring or calculating a minimum adsorption flow rate that can be processed when maintaining an optimal adsorption efficiency before the adsorbent reaches the replacement cycle, and measuring or calculating a maximum desorption flow rate that can be processed when maintaining the optimal adsorption efficiency before the adsorbent reaches the replacement cycle.

Alternatively, the processor 14 may transmit the minimum adsorption temperature and maximum desorption temperature, or the minimum adsorption pressure and maximum desorption pressure within the operable range of the operating unit 130, thereby measuring or calculating a minimum adsorption temperature or pressure that is generated when maintaining the optimal adsorption efficiency before the adsorbent reaches the replacement cycle, and measuring or calculating a maximum desorption temperature or pressure that is generated when maintaining the optimal adsorption efficiency before the adsorbent reaches the replacement cycle.

In this case, the adsorption cycle and desorption cycle output by the artificial intelligence model 160 may be stored separately so that they can be used when recovering to the normal state later, after operating the abnormal situation processing process.

As an example, after identifying an abnormal state and operating the adsorption tower 10 according to the abnormal situation processing process, when the sensing data measured by the sensor unit 110 is within the optimal range again, the adsorption tower 10 may be operaten using the adsorption cycle and desorption cycle output from the trained artificial intelligence model 160.

In this case, it is possible to output the adsorption cycle and desorption cycle by operating the artificial intelligence model 160 again, or read and use the adsorption cycle and desorption cycle output by the artificial intelligence model 160 separately stored in advance.

Therefore, the artificial intelligence-based ammonia adsorption tower operating control device 100 may identify normal and abnormal states in advance, and control the operating of the adsorption tower 10 to execute a separate adsorption process based on the identified state obtained from the sensor unit 110.

Meanwhile, the artificial intelligence-based ammonia adsorption tower operating control device 100 may be configured in a way that, if the previous adsorption cycle and previous desorption cycle performed before operating the adsorption tower 10 according to the abnormal situation processing process are different from a next adsorption cycle and a next desorption cycle (which will be used to operate the adsorption tower after the abnormal situation processing process ends), the processor 14 may calculate costs and time reduction data when operating the adsorption tower by the operating unit using the next adsorption cycle and the next desorption cycle.

Specifically, when an adsorption-desorption cycle P1 is used to operate the adsorption tower 10 before identifying the abnormal state, an exception adsorption-desorption cycle P2, and the adsorption-desorption cycle P2 output again by the artificial intelligence model 160 after returning to the normal state, the processor 14 may execute the adsorption process after finally verifying the adsorption process according to the adsorption-desorption cycle P1 and the exception adsorption-desorption cycle P2, rather than immediately executing the adsorption process using the exception adsorption-desorption cycle P2.

For example, it is possible to calculate and compare costs and operating performance efficiency to be improved occurring when changing the operating condition of the adsorption tower 10 from the adsorption-desorption cycle P1 to the exception adsorption-desorption cycle P2, before changing the adsorption and desorption cycles.

In other words, it is possible to control the adsorption tower 10 to change the adsorption and desorption cycles only when there are cost reduction and efficiency increase are greater than a preset threshold value by comparing the calculated costs and efficiency expected to be obtained by changing the adsorption and desorption cycles with the costs and efficiency of the current adsorption and desorption cycles.

Accordingly, it is possible to control the adsorption tower 10 by reflecting the comprehensive operating situation of the adsorption tower 10 in consideration of losses due to frequent changes in the adsorption and desorption cycles and process delays during the cycle change process.

Therefore, the processor 14 of the artificial intelligence-based ammonia adsorption tower operating control device 100 may transmit a command to maintain the previous adsorption cycle and the previous desorption cycle to the operating unit 130, if the calculated costs and time reduction data do not exceed the preset threshold value.

The processor 14 of the artificial intelligence-based ammonia adsorption tower operating control device 100 may transmit operating data for the adsorption tower 10 as learning data to the artificial intelligence model 160. In this case, sensing data in the abnormal state may be removed and only sensing data in the normal state may be transmitted to the artificial intelligence model 160 at each point in the process so that the abnormal state is detected by the artificial intelligence model 160.

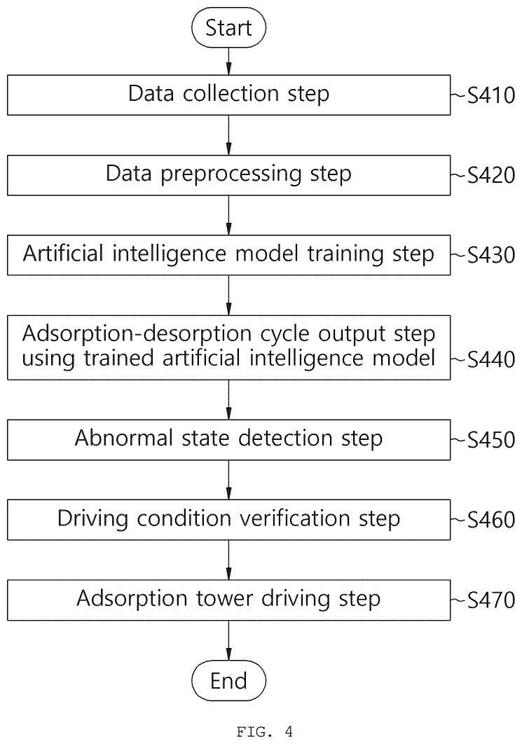

Meanwhile, as shown in FIG. 4, a control method using the artificial intelligence-based ammonia adsorption tower operating control device 100 may include the steps of: collecting sensing data obtained by measuring an internal state of the adsorption tower 10 (S310); and operating the adsorption tower 10 according to the adsorption cycle and desorption cycle set based on the sensing data (S320).

The step of operating the adsorption tower 10 may further include the steps of: outputting corresponding adsorption cycle and desorption cycle according to the sensing data using the trained artificial intelligence model 160; transmitting a command to operate the adsorption tower 10 according to the adsorption cycle and desorption cycle output when the sensing data is within a preset optimal range to the operating unit 130; and transmitting a command to execute the abnormal situation processing process according to the preset exception adsorption cycle and exception desorption cycle if the sensing data exceeds the optimal range to the operating unit 130.

Specifically, as shown in FIG. 4, the sensing data regarding the internal state of the adsorption tower 10 may be collected through the sensor unit 110 in a data collection step (S410). Then, in a data preprocessing step (S420), the sensing data may be subjected to preprocessing such as data normalization, processing of missing values, and removing abnormal values measured in the abnormal state.

In an artificial intelligence model training step (S430), the artificial intelligence model 160 may be trained using the preprocessed data to generate a model configured to predict an optimal operating condition of the adsorption tower 10. The artificial intelligence model 160 may be trained to output optimal adsorption and desorption cycles corresponding to the sensing data using a machine learning or deep learning algorithm, and in particular, may be trained to output optimal adsorption and desorption cycles in consideration of the adsorbent replacement cycle and costs, optimal adsorption efficiency, each process time and gas purity required to maintain the optimal adsorption efficiency.

Once training is complete, the optimal adsorption and desorption cycles corresponding to the current internal state of the adsorption tower 10 may be output in an adsorption-desorption cycle output step (S440) using the trained artificial intelligence model 160.

Then, an abnormal state detection step (S450) may be performed without immediately executing the adsorption and desorption processes at the predicted adsorption and desorption cycles. If an abnormal state is not detected, a operating condition verification step (S460) may be performed.

In the abnormal state detection step (S450), using the artificial intelligence model 160, the processor may determine whether the parameters detected by the sensor unit 110 deviate from the expected temperature, humidity, or pressure range according to the current amount of adsorbent and the progress of the internal process of the adsorption tower 10; determine a difference between the predicted value to be expected and the current actual value; and then, if the difference is greater than the threshold value, an abnormal state is identified and an alarm is provided to the display unit 150.

After determining the difference between the predicted value to be expected and the current actual value, if the difference is less than the threshold value and does not deviate from the normal state range, in the operating condition verification step (S460), the processor may determine whether to maintain or change the existing adsorption and desorption cycles based on the amount of adsorbent, amount of energy, application time for each step, etc. required for gas production.

Finally, when the operating condition verification is completed, an adsorption tower operating step (S470) may be performed to operate the adsorption tower 10 at the determined adsorption and desorption cycles.

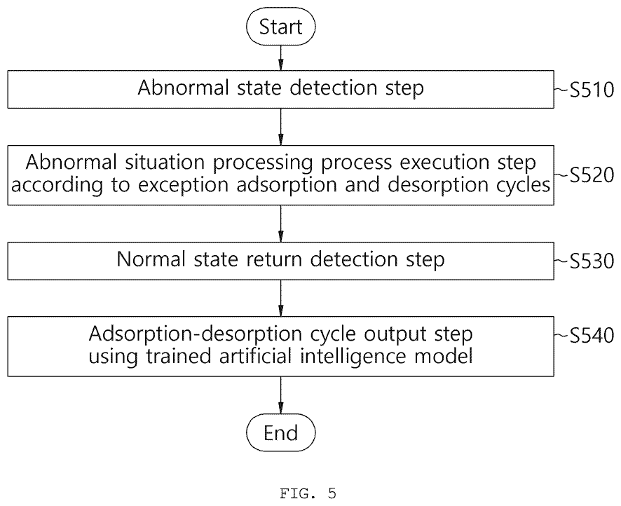

Alternately, as shown in FIG. 5, if an abnormal state is identified in an abnormal state detection step (S510), an abnormal situation processing process execution step (S520) according to the exception adsorption and desorption cycles may be performed. The abnormal state detection step (S510) is essentially the same step as S410 described above.

In the abnormal situation processing process execution step (S520), the adsorption and desorption processes may be executed according to the preset exception adsorption cycle and exception desorption cycle so as to return the internal state of the adsorption tower 10 to the normal state as quickly as possible.

Thereafter, in a normal state return detection step (S530), the adsorption and desorption processes may be executed according to the exception adsorption cycle and the exception desorption cycle. When the sensing data measured by the sensor unit 110 enters the normal state range by performing self-diagnosis, the processor 14 may detect returning to the normal state, and may perform an adsorption-desorption cycle output step (S540) using the trained artificial intelligence model 160. The adsorption-desorption cycle output step (S540) using the trained artificial intelligence model 160 is essentially the same step as S440 described above. After S540, steps S450, S460 and S470 may be performed consecutively.

In addition, after operating the adsorption tower 10 according to the output adsorption cycle and desorption cycle, if the actual process result measured by the sensor unit 110 exceeds the predicted process result and the preset range, the processor 14 of the artificial intelligence-based ammonia adsorption tower operating control device 100 may transmit a command to execute the abnormal situation processing process according to the exception adsorption cycle and the exception desorption cycle to the operating unit 130.

Alternatively, after operating the adsorption tower 10 according to the output adsorption cycle and desorption cycle, if the actual process result measured by the sensor unit 110 exceeds the predicted process result and the preset range, the processor 14 of the artificial intelligence-based ammonia adsorption tower operating control device 100 may transmit a command to cause the artificial intelligence model 160 to perform retraining.

If the sensing data of the sensor unit 110 do not deviate from the normal range but the adsorption efficiency is not improved as expected, the abnormal situation processing process may be operaten to reset the internal state of the adsorption tower 10 once, or may cause the artificial intelligence model 160 to perform retraining so as to eliminate the possibility of erroneous training.

As another embodiment, the processor 14 of the artificial intelligence-based ammonia adsorption tower operating control device 100 may determine whether an abnormal state is temporary or permanent, and apply a different abnormal situation processing process depending on the abnormal state.

When a temporary mismeasurement of the sensor unit 110 or a communication network failure occurs due to external factors, since it is a temporary abnormal state, the adsorption and desorption processes may be executed using the preset exception adsorption and desorption cycles.

If the abnormal state is caused by a malfunction of the sensor unit 110 or a communication error between at least one sensor 110 and the processor 14 due to a malfunction of the communication unit, since the abnormal state is a permanent abnormal state that cannot be resolved unless repaired from an outside, operating of the adsorption tower 10 may be stopped.

Alternatively, in the case of the permanent abnormal state, an average value of the output adsorption and desorption cycles stored in the memory 16 may be calculated, and the adsorption and desorption processes may be executed according to the calculated adsorption and desorption cycles. In order to prevent an occurrence of costs and losses while waiting for the abnormal state to be resolved, the adsorption tower 10 may be operaten at an arbitrary efficiency.

In another embodiment, when the abnormal state is an exceptional pattern that deviates from the normal state, the processor 14 may cause the artificial intelligence model 160 to perform training by patterning the parameters measured in the normal state, for example, the normal changes in the internal temperature of the adsorption tower 10, and detect an abnormal state if the pattern is changed.

As shown in FIG. 1, if the temperature profile shown in the abnormal state is different from the normal state, the artificial intelligence model 160 may detect the difference from the learned pattern and execute the abnormal situation processing process. In this case, the pattern may include a temperature profile, pressure pattern, humidity pattern, and gas concentration pattern.

Through the artificial intelligence-based ammonia adsorption tower operating control device 100 and associated processes described above, the desorption process is performed in time to enable continuous use of the adsorbent while the efficiency of the adsorption tower 10 is maintained at a predetermined level or higher, such that the adsorption tower 10 can be stably operaten not only in the normal state but also in the abnormal state.

In addition, by operating adsorption tower 10 in consideration of the costs and adsorption efficiency through simulation before and after control of the adsorption and desorption cycles, cost reduction and optimal adsorption efficiency may be maintained for a long period of time.

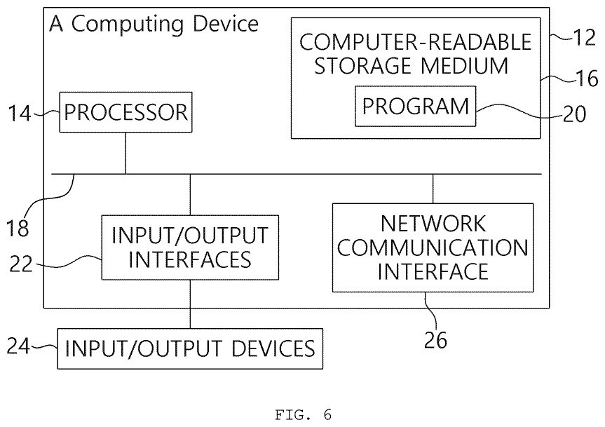

Meanwhile, as shown in FIG. 6, the artificial intelligence-based ammonia adsorption tower operating control device 100 according to the present disclosure may be implemented in the form of a recording medium which stores instructions executable by a computer. The instructions may be stored in the form of program code, and when executed by the processor, may generate a program module to perform operations of the disclosed embodiments. The recording medium may be implemented as a computer-readable recording medium.

The artificial intelligence-based ammonia adsorption tower operating control device according to the present disclosure may correspond to a computing device 12. The computing device 12 may include at least one processor 14, a computer-readable storage medium (memory) 16 including a program 20, and a communication bus 18. In addition, the computing device 12 may include one or more input/output interfaces 22 which provide interfaces for input/output devices 24 and one or more network communication interfaces 26.

The computing device 120 of the present disclosure may correspond to the computing device 12. The user interface 140 and the display unit 150 of the present disclosure may correspond to one or more input/output interfaces 22 which provide interfaces for the input/output devices 24. Therefore, all the respective components of the artificial intelligence-based ammonia adsorption tower operating control device 100 according to the present disclosure may be included in the above-described single computing device 12 or each component thereof may be implemented in separate devices.

As above, the disclosed embodiments have been described with reference to the accompanying drawings. It will be understood by persons skilled in the art to which the present disclosure pertains that the present disclosure may be embodied in forms different from the disclosed embodiments without changing the technical idea or essential features of the present disclosure. The disclosed embodiments are illustrative, and should not be interpreted as limiting.

What is claimed is:

1. An ammonia adsorption tower operate control device comprising:
a sensor unit configured to measure an internal state of an adsorption tower;
a memory configured to store one or more instructions;
a processor configured to execute one or more instructions stored in the memory; and
a operating unit configured to operate the adsorption tower according to an adsorption cycle and a desorption cycle set based on the internal state of the adsorption tower,
wherein the processor is configured to:
output corresponding adsorption cycle and desorption cycle according to sensing data of the sensor unit using a trained artificial intelligence model,
in response to the sensing data being within a preset optimal range, transmit a command to operate the adsorption tower according to the output adsorption cycle and desorption cycle to the operating unit, and
in response to the sensing data exceeding the optimal range, transmit a command to execute an abnormal situation processing process according to preset exception adsorption cycle and exception desorption cycle to the operating unit.

2. The ammonia adsorption tower operating control device according to claim 1, wherein the exception adsorption cycle and the exception desorption cycle are the shortest adsorption cycle and the longest desorption cycle within a settable cycle range of the operating unit.

3. The ammonia adsorption tower operating control device according to claim 2, wherein the command to execute the abnormal situation processing process includes parameters according to at least one of:
a minimum adsorption flow rate and a maximum desorption flow rate within a operable range of the operating unit;
a minimum adsorption temperature and a maximum desorption temperature within a operable range of the operating unit; and
a minimum adsorption pressure and a maximum desorption pressure within a operable range of the operating unit.

4. The ammonia adsorption tower operating control device according to claim 2, wherein the processor is further configured to repeatedly perform a self-diagnose at a preset cycle to determine whether the sensing data measured by the sensor unit deviate from the optimal range or whether patterns of previous sensing data and subsequent sensing data are different.

5. The ammonia adsorption tower operating control device according to claim 4, wherein, after operating the adsorption tower according to the abnormal situation processing process until the sensing data measured by the sensor unit is within the optimal range, the processor transmits a command to operate the adsorption tower using the adsorption cycle and desorption cycle output from the trained artificial intelligence model to the operating unit.

6. The ammonia adsorption tower operating control device according to claim 5, wherein the processor is further configured to:
in response to a previous adsorption cycle and a previous desorption cycle which are performed before operating the adsorption tower according to the abnormal situation processing process being different from a next adsorption cycle and a next desorption cycle which will be used to operate the adsorption tower after the abnormal situation processing process ends, calculate costs and time reduction data when operating the adsorption tower by the operating unit using the next adsorption cycle and the next desorption cycle.

7. The ammonia adsorption tower operating control device according to claim 6, wherein the processor transmits a command to maintain the previous adsorption cycle and the previous desorption cycle to the operating unit, in response to the calculated costs and time reduction data not exceeding a preset threshold value.

8. The ammonia adsorption tower operating control device according to claim 1, wherein sensing data in the abnormal state are removed and only sensing data in the normal state are transmitted to the artificial intelligence model at each point in the process so that the abnormal state is detected by the artificial intelligence model.

9. The ammonia adsorption tower operating control device according to claim 8, further comprising a user interface configured to provide an alarm to a user in response to detection of an abnormal state, and to receive information on the abnormal situation processing process.

10. The ammonia adsorption tower operating control device according to claim 4, wherein the sensor unit includes a pressure sensor, a temperature sensor, a humidity sensor, a gas sensor, an adsorbent sensor, or combinations thereof, and
the processor transmits a command to stop operating of the adsorption tower to the operating unit, in response to an occurrence of error in the sensor unit, the error being detected through self-diagnosis or by a communication error between the sensor unit and the processor.

11. An ammonia adsorption tower operation control method executed by a computing device which comprises a memory configured to store one or more instructions and a processor configured to execute the one or more instructions stored in the memory, the method comprising:
collecting sensing data obtained by measuring an internal state of an adsorption tower; and
operating the adsorption tower according to an adsorption cycle and a desorption cycle set based on the sensing data,
wherein the step of operating the adsorption tower comprises:
outputting corresponding adsorption cycle and desorption cycle according to the sensing data using a trained artificial intelligence model,
transmitting a command to operate the adsorption tower according to the output adsorption cycle and desorption cycle to a operating unit of the adsorption tower, in response to the sensing data being within a preset optimal range, and
transmitting a command to execute an abnormal situation processing process according to preset exception adsorption cycle and exception desorption cycle to the operating unit of the adsorption tower, in response to the sensing data exceeding the optimal range.

12. A computer program product for controlling an ammonia adsorption tower operation, the computer program product comprising a computer readable storage medium having a program instructions stored therein, the program instructions executable by a processor to: collect sensing data obtained by measuring an internal state of an adsorption tower; and
operate the adsorption tower according to an adsorption cycle and a desorption cycle set based on the sensing data,
wherein to operate the adsorption tower the program instructions are executable by the processor to:
output corresponding adsorption cycle and desorption cycle according to the sensing data using a trained artificial intelligence model,
transmit a command to operate the adsorption tower according to the output adsorption cycle and desorption cycle to a operating unit of the adsorption tower, in response to the sensing data being within a preset optimal range, and
transmit a command to execute an abnormal situation processing process according to preset exception adsorption cycle and exception desorption cycle to the operating unit of the adsorption tower, in response to the sensing data exceeding the optimal range.
